(19) United States
(12) Patent Application Publication
(10) Pub. No.: US 2003/0071708 A1
(43) Pub. Date: Apr. 17, 2003

(54) Inductive proximity switch

(76) Inventor: Ralf Schmidt, Freinsheim (Allemagne) (DE)

Correspondence Address: YOUNG & THOMPSON, 745 SOUTH 23RD STREET 2ND FLOOR, ARLINGTON, VA, 22202

(21) Appl. No.: 10/251,872

(22) Filed: Sep. 23, 2002

(30) Foreign Application Priority Data
Sep. 21, 2001 (DE) 01440311.7

(51) Int. Cl. H01F 27/28

(52) U.S. Cl. 336/220

(57) ABSTRACT

The invention relates to a proximity or presence switch arrangement operating by the inductive principle, which contains at least one inductor integrated in an oscillating circuit and an electronic control device connected downstream, for sensing and evaluating the approach and/or presence of a material which influences electromagnetic fields.

Arrangement characterised in that the inductor (3) integrated in the oscillating circuit (2) is designed as a secondary coil of a coil system (6) similar to a transformer, in that the corresponding primary coil (7) is subjected to an excitation signal generated by a control device (8) present in the primary circuit (7′), and in that the evaluation device (4) carries out at least one scan of the flow of current produced in the secondary circuit (3′) and emits (a) corresponding evaluation signal(s) or triggers a corresponding similar action.

The present invention relates to the field of detecting and sensing by means of electronic sensors or detectors, in particular of metal objects, and relates to a proximity or presence switch arrangement operating by the inductive principle.

Switch arrangements of this type are primarily used in conjunction with automated operating devices (for example robots) or with safety devices, in particular in the automotive industry.

The inductors present in the known switch arrangements are supplied with an oscillating electric signal and thus develop a changeable magnetic sensing field, the nature of which depends on the nature of the inductor and the features of the supplied signal.

Inductive sensors of this type operate with LC oscillating circuits, wherein the “L” coil is inclined to the active face and can be influenced in its properties by an external magnetic damping element.

The LC oscillating circuit forms an oscillating system which automatically oscillates at a certain frequency.

The oscillating conditions are no longer provided owing to the coil being influenced by a damping element, so the oscillation breaks off until the influence is eliminated or is sufficiently suppressed and the oscillator can begin to swing again.

In actual fact if a metal object enters the region of the sensing field, the latter is changed by the effect of this object changing the electromagnetic field. This change is detected and evaluated in order to possibly initiate actions if predetermined conditions occur or are exceeded, such as changes in the switching state of connected switching amplifiers.

If these switching arrangements are used in an industrial environment they are exposed to influences which disturb measurement and sensing, such as metallic dust or welding particles which can accumulate on the housing, or strong electromagnetic interference fields.

A switch arrangement of the type mentioned at the outset is already known in which an attempt is made to compensate the measurement-disturbing influences by an additional arrangement.

However, this results in a complex structure in which the compensating component is itself exposed to disturbing influences and therefore cannot always optimally compensate.

In addition it has to be mentioned that a constant supply of energy is required in all existing, aforementioned arrangements.

Finally it has to be mentioned that the known inductive switch arrangements with LC oscillating circuits require components with consistent storage capacities (and are accordingly voluminous) and the duration of the detection phases is continuous.

It is therefore an object of the invention to eliminate at least some of the aforementioned drawbacks.

Therefore the invention primarily relates to a proximity or presence switch arrangement operating by the inductive principle, which contains at least one inductor integrated in an oscillating circuit and an electronic control and evaluation device connected downstream, for sensing and evaluating the approach and/or presence of a material or object influencing electromagnetic fields, characterised in that the inductor integrated in the oscillating circuit is designed as a secondary coil of a coil system similar to a transformer, in that the corresponding primary coil is subjected to an excitation signal generated by a control device present in the primary circuit, and in that the evaluation and control device scans the current produced in the secondary circuit or a variable dependent thereon at one or more preadjusted and suitable instant(s) within a period of the excitation signal, and emits (a) corresponding evaluation signal(s) or triggers a corresponding similar action.

The invention will be described in more detail hereinafter with reference to embodiments and in conjunction with further features in conjunction with the accompanying figures, in which:

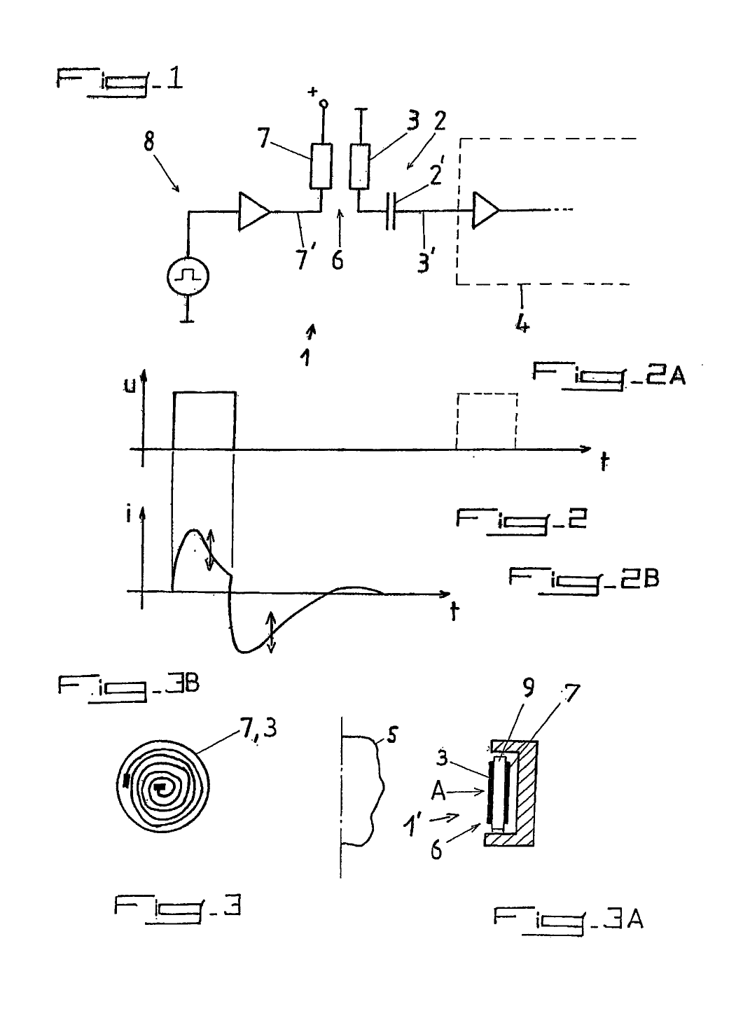

FIG. 1 is a simplified schematic circuit diagram of a proximity or presence switch arrangement according to the invention;

FIG. 2A shows a time graph of the control pulse signal generated in the primary circuit;

FIG. 2B shows a time graph of the flow of current resulting in the secondary circuit;

FIG. 3A is a side view of a coil system which is part of the arrangement shown in FIG. 1, according to a specific embodiment of the invention;

FIG. 3B is a view in the direction A of the coil system of FIG. 3A.

Referring to FIG. 1, the invention relates to a proximity or presence switch arrangement 1 operating in according with the inductive principle, which contains at least one inductor 3 integrated in an oscillating circuit 2 and an electronic control and evaluation device 4 connected downstream, for sensing and evaluating the approach and/or presence of a material or object 5 influencing electromagnetic fields.

According to the invention this arrangement 1 is characterised in that the inductor 3 integrated in the oscillating circuit 2 is designed as a secondary coil of a coil system 6 similar to a transformer, in that the corresponding primary coil 7 is subjected to an iterative or a periodic excitation signal generated by a control device 8 present in the primary circuit 7′, and in that the evaluation and control device 4 scans the current produced in the secondary circuit 3′ or a variable dependent thereon at one or more preadjusted and suitable instant(s) within a period of time, and emits (a) corresponding evaluation signal(s) or triggers a corresponding similar action.

In FIG. 1 the control device 8 consists of an excitation signal generator and of a signal amplifier connected downstream. Only an entry-side assembled signal amplifier of the evaluation and control device 4 can be seen.

The LC oscillating circuit 2 can be formed by coil 3 and capacitor 2′ either mounted in series or in parallel.

To keep the electromagnetic susceptibility of the arrangement as low as possible and thus to optimise the dependability of the detections, the components of the secondary circuit 3′ and the coupling between primary coil 7 and secondary coil 3 are determined in such a way that a flow of current can still be registered in the secondary circuit 3′ during the application and/or the presence of the excitation signal in the primary circuit 7′.

In addition, the evaluation and control device 4 performs recurrently, but not necessarily at equal time intervals, at least one scan of the current signal in the secondary circuit 3′ during the application and/or the presence of the excitation signal in the primary circuit 7′, the excitation signal preferably consisting of periodic or non-periodic, successive current or voltage pulses (FIG. 3A).

The current signal flow can also be readily observed after the excitation pulse but is substantially more sensitive to external interference.

Therefore, scanning is brought forward into the time range of the excitation pulse, as the oscillation is forced at this point by the primary-side excitation.

Either the primary coil 7 or equally the secondary coil 3 can be exposed solely or primarily to the influence of a possibly present or existing electromagnetically influencing material or object 5 and thus be arranged to face the active face 1′ of the arrangement 1 and/or in the immediate vicinity of this face 1′.

The two coils 7 and 3 can optionally be separated by a magnetically impermeable wall.

According to a preferred embodiment of the invention, and as emerges from FIG. 2 (FIG. 2A and FIG. 2B), the parameter obtained and evaluated from the current signal scanned in the secondary circuit 3′ is the current signal course (in particular the signal amplitude) which changes under the influence of an electromagnetically influencing material 5 and changes its distance from the active face 1′.

The evaluation and control device 4 contains means for comparing the scanned current signal amplitude value with a threshold corresponding to a distance and for triggering or changing over a switching amplifier connected downstream.

The evaluation and control device 4 can alternately contain means for emitting an analogue voltage or current value dependent on the scanned signal amplitude and corresponding to a distance.

To obtain an extremely compact structure for the arrangement 1 it can be provided that the primary coil 7 and/or the secondary coil 3 is (are) designed as printed circuit board tracks, wherein only a few turns can be required for each coil.

As shown in FIG. 3 (FIG. 3A and FIG. 3B), the coil system 6 acting as a transformer can advantageously consist of a printed circuit board 9 printed on one side, both sides or on multiple layers, wherein the board body can form a magnetic partition.

The present invention also relates to a method for detecting the presence and/or approach of a material influencing electromagnetic fields, for example by using a switch arrangement 1 as has been described above.

This method primarily incorporates the following steps:

generating an electric current in the primary coil 7 of a multi-coil system 6 similar to a transformer by means of a current pulse, so a flow of current can be recorded in the secondary coil 3 of the coil system 6 at least for the pulse duration, which secondary coil 3 is part of a serial or parallel LC oscillating circuit 2;

scanning the current signal induced in the secondary circuit 3′ by an electronic evaluation and control device 4 in one or more appropriate time range(s) before supplying the next current pulse in the primary circuit 7, wherein this current signal is changed in its characteristic (in particular in its amplitude) by the presence and as a function of the distance of a possible electromagnetically influencing material or object 5;

comparing the scanned values with a threshold and possibly triggering a switching amplifier connected downstream or processing the scanned value in the electronic control and evaluation device 4 and emitting an analogue voltage or current value corresponding to the distance;

repeating the preceding steps in conjunction with repeatedly supplied current pulses in the primary circuit 7′.

Scanning is preferably carried out during the supply and/or the presence of an (in particular square) excitation pulse in the primary circuit 7′ and one of the primary and secondary coils 7, 3 is exposed in a preferred manner to the influence of a possible external, electromagnetically influencing material 5.

In conjunction with the progress of the method according to the invention, the switching on of the primary current by a current pulse causes an excitation of a resonance circuit in the secondary winding, which circuit is formed by this excitation in conjunction with a capacitor.

For the pulse duration, therefore, a flow of current can be registered in the secondary circuit which, in turn, changes owing to the presence of a material approaching from the outside and influencing the electromagnetic field (for example a damping element BE).

Therefore, a signal amplitude corresponding to the distance of the BE is produced by scanning in an appropriate time range within the period between two transmission pulses.

In conclusion, the operating principle of the invention corresponds to that of a transformer system in which the stimulation of oscillations of a secondary-side resonance circuit (in series or parallel) is brought about and assessed by the primary-side pulse excitation (external excitation/non-natural frequency).

Up to a predetermined scanning time this stimulation of oscillations achieves a certain amplitude value which is positively or adversely affected by an external damping material or object (see FIG. 2B).

The system manages with very low inductances 7 and 3 making it suitable, for example, for applications which demand a low memory effect in inductors and capacitors.

Of course the invention is not restricted to the embodiments described and illustrated. Changes, for example in the embodiments of the various components or replacement by technical equivalents are always possible, providing they remain within the scope of the claimed protection.

1. A proximity or presence switch arrangement operating by the inductive principle, which contains at least one inductor integrated in an oscillating circuit and an electronic control and evaluation device connected downstream, for sensing and evaluating the approach and/or presence of a material or object influencing electromagnetic fields, characterised in that the inductor (3) integrated in the oscillating circuit (2) is designed as a secondary coil of a coil system (6) similar to a transformer, in that the corresponding primary coil (7) is subjected to an excitation signal generated by a control device (8) present in the primary circuit (7′), and in that the evaluation and control device (4) scans the current produced in the secondary circuit (3′) or a variable dependent thereon at one or more preadjusted and suitable instant(s) within a time period of the excitation signal, and emits (a) corresponding evaluation signal(s) or triggers a corresponding similar action.

2. Proximity or presence switch arrangement according to claim 1, characterised in that the components of the secondary circuit (3′) and the coupling between primary coil (7) and secondary coil (3) are determined such that a flow of current can still be registered in the secondary circuit (3′) during the application and/or presence of the excitation signal in the primary circuit (7′), and in that the evaluation and control device (4) carries out at least one scan of the current signal in the secondary circuit (3′) during the application and/or the presence of the excitation signal in the primary circuit (7′), the excitation signal preferably consisting of periodic or non-periodic, successive current or voltage pulses.

3. Proximity or presence switch arrangement according to claim 1 or 2, characterised in that the secondary coil (3) is exposed solely or predominantly to the influence of a possibly present or existing electromagnetically influencing material or object (5) and is arranged to face the active face (1′) of the arrangement (1) and/or in the immediate vicinity of this face (1′).

4. Proximity or presence switch arrangement according to claim 1 or 2, characterised in that the primary coil (7) is exposed, solely or predominantly, to the influence of a possibly present or existing electromagnetically influencing material or object (5) and is arranged to face the active face (1′) of the arrangement (1) and/or in the immediate vicinity of this face (1′).

5. Proximity or presence switch arrangement according to any of claims 1 to 4, characterised in that the parameter obtained and evaluated from the current signal scanned in the secondary circuit (3′) is the current signal flow which changes under the influence of an electromagnetically influencing material (5) and changes its distance from the active face (1′), and in that the evaluation and control device (4) contains means for comparing the scanned current signal amplitude value with a threshold corresponding to a distance and for triggering or changing over a switching amplifier connected downstream.

6. Proximity or presence switch arrangement according to any of claims 1 to 4, characterised in that the parameter obtained and evaluated from the current signal scanned in the secondary circuit (3′) is the current signal flow which changes under the influence of an electromagnetically influencing material (5) and changes its distance from the active face (1′), and in that the evaluation and control device (4) contains means for emitting an analogue voltage or current value dependent on the scanned signal amplitude and corresponding to a distance.

7. Proximity or presence switch arrangement according to any of claims 1 to 6, characterised in that the primary coil (7) and/or the secondary coil (3) is (are) designed as printed circuit board tracks.

8. Proximity or presence switch arrangement according to claim 7, characterised in that the coil system (6) acting as a transformer consists of a printed circuit board (9) printed on one side, both sides or on multiple layers.

9. Method for detecting the presence and/or approach of a material influencing electromagnetic fields, for example by using a switch arrangement (1) according to any of claims 1 to 8, characterised in that this method incorporates the following steps:
generating an electric current in the primary coil (7) of a multi-coil system (6) similar to a transformer by means of a current pulse, so a flow of current can be registered in the secondary coil (3) of the coil system (6) at least during the pulse, which secondary coil (3) is part of a serial or parallel LC oscillating circuit (12);
scanning the current signal induced in the secondary circuit (3′) using an electronic evaluation and control device (4) in one or more appropriate time range(s) before supplying the next current pulse in the primary circuit (7), this current signal being changed in its amplitude by the presence and as a function of the distance of a possible electromagnetically influencing material or object (5);
comparing the scanned values with a threshold and possibly triggering a switching amplifier connected downstream or processing the scanned value in the electronic control and evaluation device (4) and emitting an analogue voltage or current value corresponding to the distance;
repeating the preceding steps in conjunction with repeatedly supplied current pulses in the primary circuit (7′).

10. Method according to claim 9, characterised in that scanning is carried out during the supply and/or the presence of the excitation pulse in the primary circuit (7′), and in that one of the primary and secondary coils (7, 3) is preferably exposed to the influence of a possibly external, electromagnetically influencing material (5).
